(19) United States
(12) Patent Application Publication
(10) Pub. No.: US 2016/0366841 A1
(43) Pub. Date: Dec. 22, 2016

(54) CROP CANOPY TEMPERATURE CONTROLLED IRRIGATION SYSTEM

(71) Applicant: Lindsay Corporation, Omaha, NE (US)

(72) Inventor: Timothy Del Wilson, Omaha, NE (US)

(21) Appl. No.: 14/741,130

(22) Filed: Jun. 16, 2015

(51) Int. Cl. A01G 25/16; B05B 1/20; B05B 13/00; A01G 25/09

(52) U.S. Cl. CPC A01G 25/16; A01G 25/092; B05B 1/20; B05B 13/005

(57) ABSTRACT

An irrigation system including a series of mobile towers and horizontally extending spans, an irrigation fluid conduit, a number of nozzles, sensor booms, and crop sensors, and a control system. The sensor booms extend forwardly from the horizontally extending spans. The sensors are positioned near the ends of the sensor booms in front of the spray range of the nozzles and sense crop temperature or other parameters. The irrigation system irrigates the crops according to crop data analyzed by the processor in a closed-loop, real-time control scheme. In this way, the crops can be irrigated according to current crop needs with little to no user input.

### BACKGROUND

Modern mobile irrigation systems such as center-pivot irrigation systems and lateral-move irrigation systems irrigate crops according to crop water needs as determined from soil moisture sensors, weather stations, and other sources. Despite the plethora of data provided, many factors can change between the time the data is collected and the time the irrigation system reaches the targeted crops. For example, recent precipitation, wind, and irrigation system progression may make collected data obsolete and therefore must be estimated according to various probabilities and assumptions. Watering schedules generated according to the available data are essentially only as accurate as these probabilities and assumptions.

### SUMMARY

The present invention solves the above-described problems and provides a distinct advance in the art of irrigation control systems. More particularly, the present invention provides an irrigation system that irrigates according to closed-loop, real-time crop data acquisition and control schemes. An embodiment of the irrigation system broadly includes a number of support towers, horizontally extending spans, nozzles, sensor booms, and sensors, and a control system.

The support towers support the horizontally extending spans and may be conventional A-frame towers having a number of wheels and drive motors. The support towers may be spaced apart from each other near ends of the horizontally extending spans.

The horizontally extending spans support an irrigation conduit extending from an irrigation source to an end of the irrigation system and extend between adjacent support towers. The horizontally extending spans may be pivotally connected to each other near the support towers for providing flexibility to the irrigation system as it traverses the field.

The nozzles dispense irrigation fluid such as water or agricultural chemicals onto the crops or field and are spaced apart from each other along the horizontally extending spans. The nozzles have a spray range extending in front of and/or behind the horizontally extending spans. The nozzles may be drip nozzles, fixed flow nozzles, variable flow rate nozzles, an end gun, or any other type of nozzle, hose, or sprayer.

The sensor booms suspend the sensors in front of the spray range of the nozzles and are spaced apart from each other along the horizontally extending spans. The sensor booms extend forwardly from the horizontally extending spans and may be lightweight and flexible. The sensor booms may also be automatically or manually raised and lowered.

The sensors sense crop or field temperature, humidity, or any other parameter and may be positioned near the end of the sensor booms so that their readings are not affected by the irrigation fluid being dispensed by the nozzles. The sensors may be temperature sensors, moisture sensors, chemical sensors, or any other type of sensor.

The control system determines crop needs based on the sensor readings and a crop water stress index (CWSI) and controls the irrigation system according to the crop needs and other inputs. The control system includes a number of processors, motor and nozzle controllers, memories, and/or transceivers. The control system may be a stand-alone system or may communicate and interface with other control systems, remote computer systems, servers, and mobile computing devices.

The processor activates the sensors, manages sensor signals, interprets the signals as computer data, communicates with other control and/or computer systems, receives user input, and instructs the motor and nozzle controllers to activate the motors and nozzles as required.

The motor controllers active the motors according to movement instructions received from the processor. Each motor controller may be responsible for a single motor or may activate paired or grouped motors located at each tower.

The nozzle controllers activate the nozzles according to irrigation instructions received from the processor and may be part of a variable rate irrigation (VRI) system. Each controller may be responsible for a single nozzle or may activate paired or grouped nozzles positioned along the horizontally extending spans.

The transceiver transmits and receives sensor data, user input, movement and irrigation instructions, and navigational information between the processor, motor and nozzle controllers, mobile computing devices, remote computer systems and servers, GPS satellites, and weather stations.

The irrigation system may irrigate crops in a field as follows. First, the motors may be driven so as to position the sensors near a first swath of crops. The sensors may then sense a first set of crop information corresponding to the first swath of crops. For example, the sensors may sense crop leaf canopy temperatures along the first swath. The processor may then determine a first set of irrigation fluid amounts needed by crops in the first swath based on the first set of crop information. For example, the processor may calculate a crop water schedule using the CWSI based on the crop leaf canopy temperatures and then calculate the amount of water required to eliminate the crop stress of the crops in the first swath. The motors may then be driven so as to position the irrigation nozzles near the first swath of crops and simultaneously position the sensors near a second swath of crops. The irrigation fluid output for each nozzle may then be increased or decreased according to the first set of irrigation fluid amounts so that crops in the first swath are irrigated as needed.

The sensors may also sense a second set of crop information, such as crop leaf canopy temperatures, corresponding to the second swath of crops as the first swath of crops is being irrigated. The processor may then determine a second set of irrigation fluid amounts needed by the second swath of crops based on the second set of crop information, as described above. The motors may then be driven so as to position the irrigation nozzles near the second swath of crops. The irrigation fluid output for each nozzle may then be increased or decreased according to the second set of irrigation fluid amounts.

The closed-loop, real-time control scheme of the irrigation system responds to crop water requirements immediately, thus reducing the number of estimations and assumptions required to calculate the water requirements. This reduces crop stress, increases crop uniformity, increases crop yield, saves water, and reduces pumping costs. The irrigation system may continue moving and irrigating indefinitely until instructed to stop or shut down. In this way, the irrigation system may irrigate a field with little or no user input. In addition, the irrigation system may easily be repurposed, modified, and adapted for different crops and fields or changes in conditions. As the irrigation system moves along the field, areas or sections of crops are irrigated according to their irrigation needs. The areas or sections can be polygons, grid spaces, a continuous gradient, or any other delimiting mechanism. When used in conjunction with a VRI system and/or a variable frequency drive (VFD) pump, crops may be irrigated within small tolerances via small and/or large flow zones while maintaining an appropriate motor speed without over-watering or under-watering.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a center pivot irrigation system constructed in accordance with an embodiment of the present invention;

FIG. 2 is a plan view of the irrigation system of FIG. 1;

FIG. 3 is a schematic diagram of the control system of the irrigation system of FIG. 1;

FIG. 4 is a schematic diagram of the irrigation system of FIG. 1 in communication with a remote server and a mobile device over a wireless network; and

FIG. 5 is a flow chart of a method of operating the irrigation of FIG. 1.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

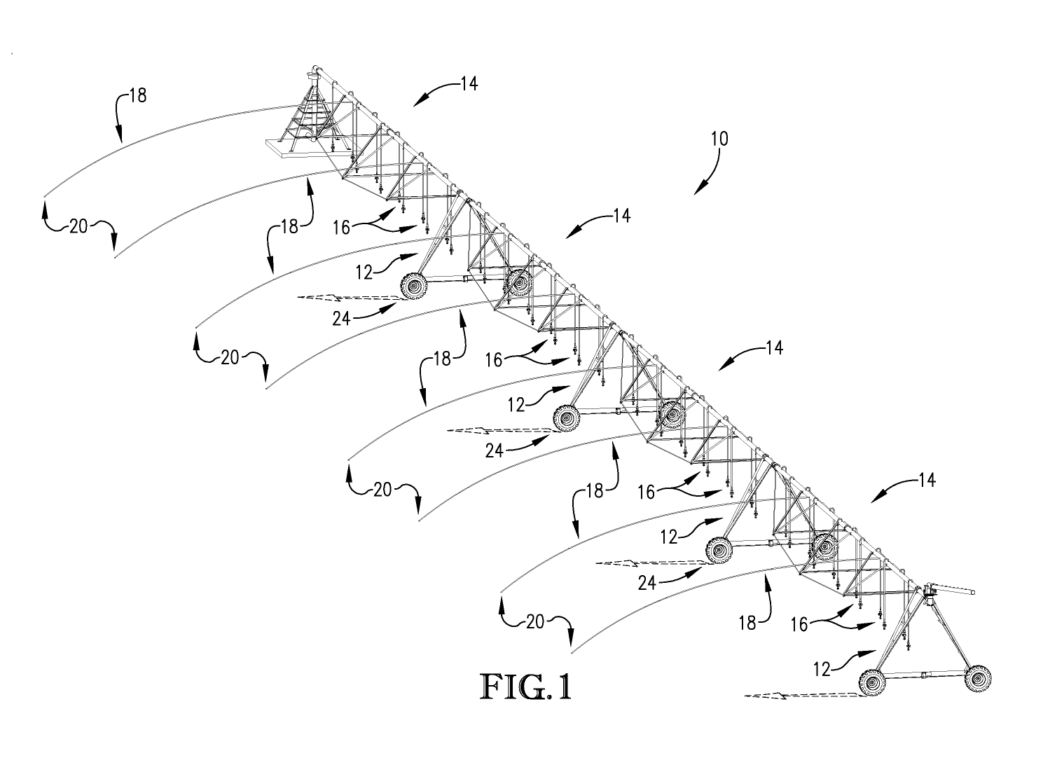

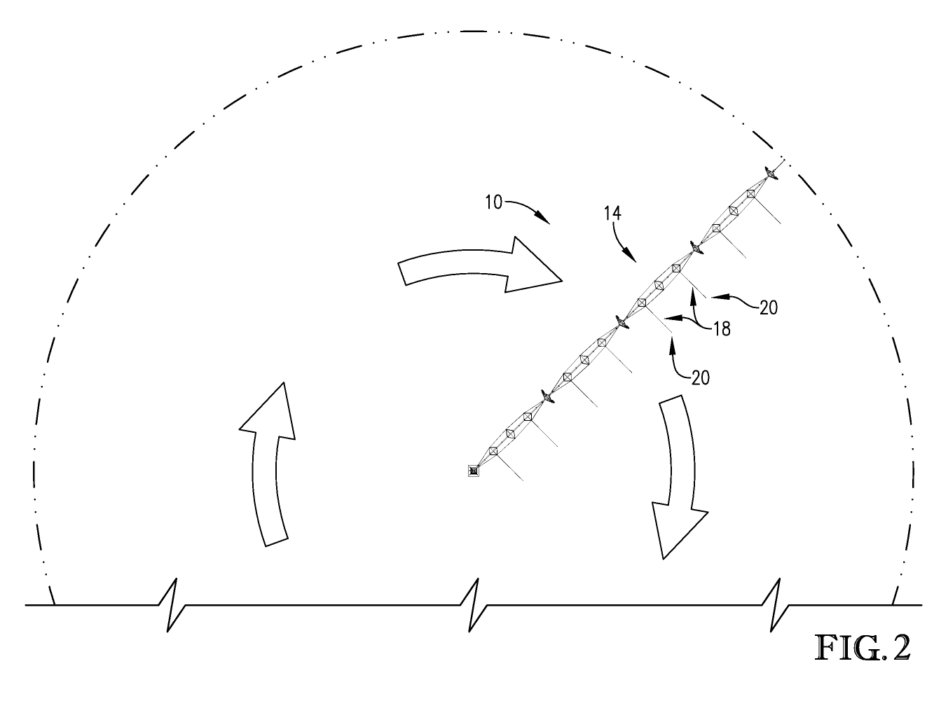

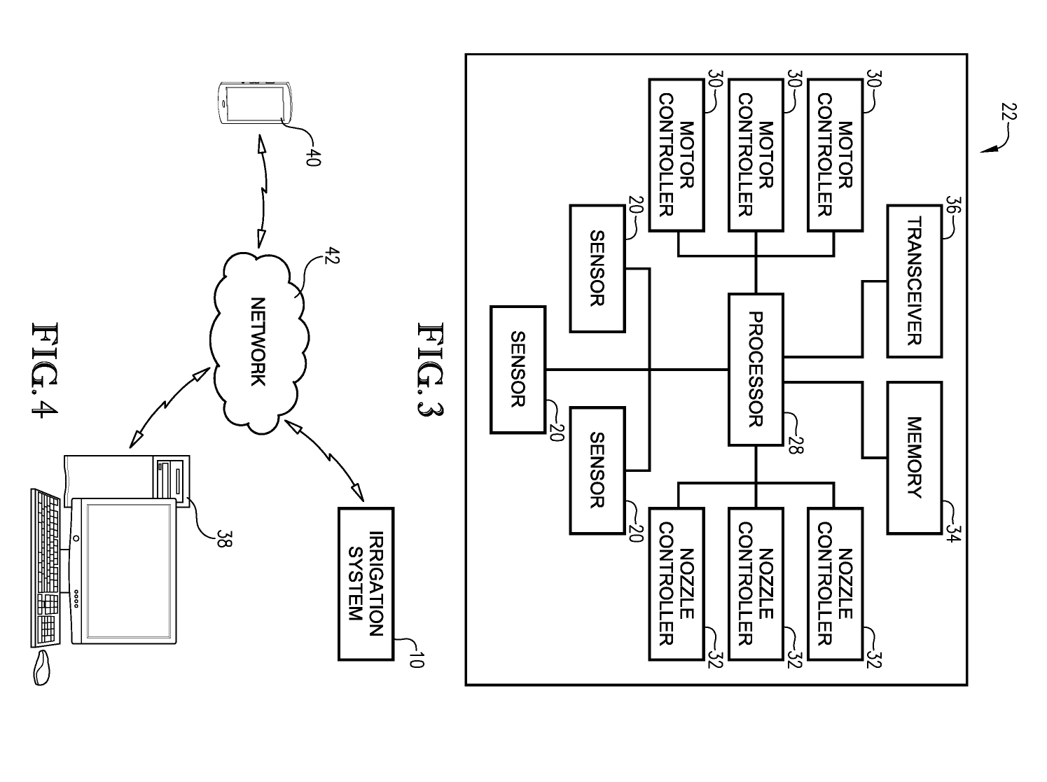

Turning now to the drawing figures, and FIGS. 1-3 in particular, an irrigation system 10 constructed in accordance with an embodiment of the invention is illustrated. The irrigation system 10 is a center pivot irrigation system that broadly comprises one or more support towers 12, one or more horizontally extending spans 14, a plurality of nozzles 16, a plurality of sensor booms 18, a plurality of sensors 20, and a control system 22.

The support towers 12 support the horizontally extending spans 14 and include wheels 24 and one or more motors 26. The support towers 12 may be spaced a predetermined distance from each other at the ends of the horizontally extending spans 14 beginning with a first support tower 12 spaced from a central pivot point. The wheels 24 traverse concentric paths in a field to be irrigated and each may be independent or linked to its companion wheel via tracks or drive linkages. Each motor 26 may independently drive one of the wheels 24 or may drive more than one wheel of the support tower 12. The motors 26 may be fixed speed, multiple speed, or variable speed, e.g., variable frequency drive (VFD) motors, and in some embodiments may reverse direction.

The horizontally extending spans 14 extend between the support towers 12 and support an irrigation fluid conduit extending radially from the central pivot point to the end of the irrigation system 12. The horizontally extending spans 14 may each be pivoted with respect to each other to allow flexibility in the irrigation system 10 as the wheels 24 of each support tower 12 traverse the field.

The nozzles 16 dispense irrigation fluid such as water or agricultural chemicals onto the crops or field and may be spaced along the horizontally extending spans 14 at predetermined intervals. The nozzles 16 may have a spray range such as twenty feet in front of the horizontally extending span 14 to twenty feet behind the horizontally extending span 14, ten feet in front of the span 14 to ten feet behind the span 14, or any other suitable range. The spray range may elongate or shorten depending on the amount of irrigation fluid being dispensed or the pressure in the irrigation fluid conduit. The nozzles 16 may be drip irrigation nozzles, fixed flow nozzles, variable flow rate nozzles for variable rate irrigation (VRI) systems, an end gun, or any other type of nozzle. The nozzles 16 may be fed by a plurality of valves as part of a VRI system.

The sensor booms 18 suspend the sensors 20 in front of the spray range of the nozzles 16 and extend forwardly and substantially horizontally from the horizontally extending spans 14. The sensor booms 18 may each extend perpendicular to the horizontally extending spans 14 or may be decreasingly angled inward from the sensor boom 18 nearest the center pivot point to the sensor boom 18 furthest from the center pivot point to account for differences in curvature of the travel paths of each sensor 20. However, the curvature differences in most embodiments may be minimal such that the simplicity of uniformly oriented sensor booms 18 may be more desirable. The sensor booms 18 may each be approximately forty feet long or any other length for retaining the sensors in front of the spray range of the nozzles 16. The sensor booms 18 may be of lightweight design and construction since they are not load-bearing. To that end, the sensor booms 18 may bend under their own weight so long as the sensors 20 are positioned within a desired height range above the ground and/or the crop canopy, as described above. In some embodiments, the sensor booms 18 may be raised or lowered, or flexed or relaxed, to raise or lower the sensors 20.

The sensors 20 sense crop or field temperature, humidity, or any other crop or field parameter and are positioned near the ends of the sensor booms 18 so that their readings are not affected by the irrigation fluid being dispensed by the nozzles 16. The sensors 20 may be positioned a predetermined height above the ground or crop leaf canopy for generating accurate readings. In one embodiment, the sensors 20 are crop leaf canopy temperature sensors suspended near the height of a full or almost full crop leaf canopy. The sensors 20 may be temperature sensors, moisture sensors, chemical sensors, or any other type of sensor.

The control system 22 determines crop needs based on the sensor readings and controls the irrigation system 10 according to the crop needs and other inputs. The control system 22 broadly comprises one or more processors 28, motor controllers 30, nozzle controllers 32, memories 34, and/or transceivers 36. The control system 22 may be a stand-alone system or may communicate and interface with other control systems, remote computer systems, servers, and mobile computing devices as described below.

The processor 28 activates the sensors 20, manages sensor signals, interprets the signals as computer data, communicates with other control systems and remote computer systems, receives user input, and instructs the motor controllers 30 and nozzle controllers 32 to activate the motors and nozzles, as described below. The processor 28 may run computer programs that may comprise ordered listings of executable instructions for implementing logical functions. The computer programs may be stored in or on computer-readable medium residing on or accessible by the processor 28. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The motor controllers 30 activate the motors 26 according to movement instructions received from the processor 28 and may operate independently or in connection with other controllers and processors. Each motor controller 30 may be responsible for a single motor or may activate paired or grouped motors 26 located at each support tower 12. The motor controllers 30 may communicate wirelessly or via a wired connection with the processor 28.

The nozzle controllers 32 activate the nozzles 16 according to irrigation instructions received from the processor 28 and may operate independently or in connection with other controllers and processors. Each nozzle controller 32 may be responsible for a single nozzle or may activate paired or grouped nozzles 16 positioned along each horizontally extending span 14. The nozzle controllers 32 may communicate wirelessly or via a wired connection with the processor 28.

The memory 34 stores sensor data, computer programs, user input, and movement and irrigation instructions thereon and may be any conventional memory component or network of memory components. The memory 34 may reside on the irrigation system 10, in a nearby computing station, or in a remote location.

The transceiver 36 transmits and receives sensor data, user input, movement and irrigation instructions, and navigational information between the processor 28 and other processors, remote computer systems and servers 38, Global Positioning System (GPS) satellites, one or more mobile computing devices 40, motor controllers 30, and nozzle controllers 32 over a wireless communications network 42, as shown in FIG. 4.

The wireless communications network 42 may be the internet or any other communications network such as a local area network, wide area network, or an intranet. The wireless communications network 42 may include or be in communication with a wireless network capable of supporting wireless communications such as the wireless networks operated by AT&T, Verizon, or Sprint. The wireless communication network 42 may also be combined or implemented with several different networks.

The remote computer systems and servers 38 provide additional crop analysis and information, weather information, and irrigation system control calculations as needed. In some embodiments, the remote computer systems and servers 38 host an irrigation system management website for allowing farmers to track their irrigation systems. The remote computer systems and servers 38 communicate with the processor 28 via the wireless communications network 42 and may perform some or all of the movement and irrigation calculations described herein. In some embodiments, the remote computer systems and servers 38 may provide supplemental crop analysis and control instructions as required, as described below.

The mobile computing device 40 allows the farmer to manage the irrigation system 10 on-site or remotely at any time and may be a smartphone, tablet, laptop, personal digital assistant (PDA), game system, or any other computing device. The mobile computing device 40 may run a mobile irrigation management application or program and may display a user interface for allowing the farmer to log into an irrigation management account, monitor and manage the irrigation system 10 and other irrigation systems, and control the irrigation system 10 by inputting commands into the user interface.

Use of the irrigation system 10 will now be described in more detail. In some embodiments, the crops of the field may need to be established first and have a full or close to a full leaf canopy before the sensors 20 may be used for gathering crop information. A soil moisture reservoir may also need to be at field capacity before use. In addition, the irrigation system 10 may need to be tailored to certain soil conditions before use.

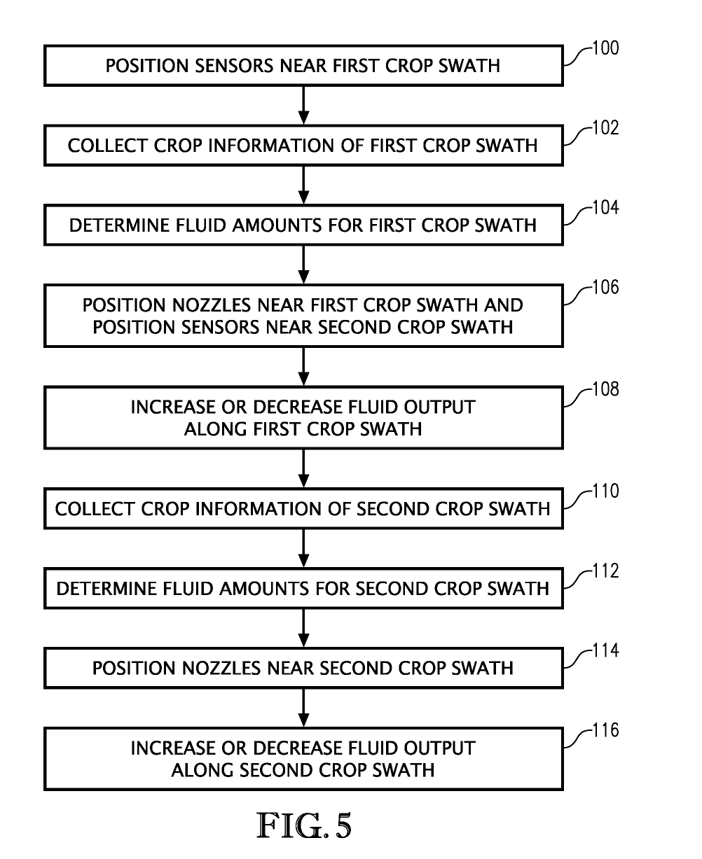

Once the crops and/or field is prepared for irrigation, the irrigation system 10 may be moved so that the sensors 20 are positioned near a first swath of crops, as shown in block 100 of FIG. 5. This may be an initial starting position or any current position. In some instances, positioning the sensors 20 near the first swath of crops may require the processor 28 to instruct the motor controllers 30 to active the motors 26 and drive the support towers 12 until the sensors 20 have reached the first swath of crops.

The sensors 20 may then collect a first set of crop information corresponding to the first swath of crops, as shown in block 102. The first set of crop information may be crop leaf canopy temperatures, humidity, or chemical levels depending on the sensor type, crop type, environmental conditions, and irrigation methods. The first set of crop information may be divided into sectors or sections (e.g., portions of two dimensional polygons, spaces of a grid, portions of a continuous gradient, or other delimiting mechanism) according to the sensor, the distance from the center pivot point, or any other metric, or the crop information may be a continuous or nearly continuous batch or stream of crop information along the first swath of crops.

The processor 28 may then analyze the crop information of the first swath of crops and determine irrigation fluid amounts required for the first swath of crops, as shown in block 104. Alternatively, the processor 28 may transmit the crop information to the remote computer systems and servers 38 for analysis. In some embodiments, the required fluid amounts are determined by calculating a crop water stress index (CWSI) based on the temperatures of the crop leaf canopy temperatures. The required fluid amounts may be uniform along the entire swath or may vary according to the sectors, sections, or nozzle. Alternatively, the required fluid amounts may be a substantially continuous profile along the swath. The required fluid amounts may take into account ground type, current ground saturation, weather, terrain, field position, and other factors.

The processor 28 may then instruct the motor controllers 30 to activate the motors 26 until the nozzles 16 are positioned near the first swath of crops, as shown in block 106. The motor controllers 30 may operate the motors 26 at slow or high speeds or variably ramp up or ramp down the motor speeds, as discussed below. The sensors 20 will simultaneously be positioned near a second swath of crops when the nozzles 16 are positioned near the first swath of crops since the sensors 20 are mounted on the sensor booms 18.

The processor 28 may then instruct the nozzle controllers 32 to increase or decrease irrigation fluid output along the first swath of crops, as shown in block 108. The irrigation fluid output may be uniform along the entire swath or may vary according to the sectors, sections, or nozzles as described above. Alternatively, the irrigation fluid output may be a substantially continuous profile along the swath. The irrigation fluid output for each nozzle 16 may take into account overlapping spray areas for adjacent nozzles, nozzle position along the irrigation system 10, fluid pressure, fluid availability, fluid prices, weather, and other factors.

The sensors 20 may then collect a second set of crop information corresponding to the second swath of crops, as shown in block 110. The second set of crop information may be crop leaf canopy temperatures, humidity, or chemical levels depending on the sensor type, crop type, environmental conditions, and irrigation methods. The second set of crop information may be divided into sectors or sections (e.g., portions of two dimensional polygons, spaces of a grid, portions of a continuous gradient, or other delimiting mechanism) according to the sensor, the distance from the center pivot point, or any other metric, or the crop information may be a continuous or nearly continuous batch or stream of crop information along the second swath of crops.

The processor 28 may then analyze the crop information of the second swath of crops and determine irrigation fluid amounts required for the second swath of crops, as shown in block 112. Alternatively, the processor 28 may transmit the crop information to the remote computer systems and servers 38 for analysis. The required irrigation fluid amounts may be determined as described above.

The processor 28 may then instruct the motor controllers 30 to activate the motors 26 until the nozzles 16 are positioned near the second swath of crops, as shown in block 114. The motor controllers 30 may operate the motors 26 at slow or high speeds or variably ramp up or ramp down the motor speeds, as discussed below. The sensors 20 will simultaneously be positioned near a third swath of crops when the nozzles 16 are positioned near the second swath of crops.

The processor 28 may then instruct the nozzle controllers 32 to increase or decrease irrigation fluid output along the second swath of crops, as shown in block 116. The irrigation fluid output may be uniform along the entire swath or may vary according to the sectors, sections, or nozzles as described above. Alternatively, the irrigation fluid output may be a substantially continuous profile along the swath. The irrigation fluid output for each nozzle 16 may take into account overlapping spray areas for adjacent nozzles, nozzle position along the irrigation system 10, fluid pressure, fluid availability, fluid prices, weather, and other factors.

The above pattern may be performed continuously and/or seamlessly such that the irrigation system 10 moves along the field irrigating the crops while simultaneously sensing crop information ahead of the current location of the nozzles 16. As such, the current swath of crops near the sensors and the current swath of crops near the nozzles at any given time may be seen to move along with the irrigation system 10. It will be understood that the irrigation fluid output near the center pivot point (for center-pivot irrigation systems) may be less than the irrigation fluid output near the outer edge of the field since the outer end of the irrigation system 10 must travel a greater distance and must water a greater area than the inner end of the irrigation system 10.

As mentioned above, the processor 28 may instruct the motor controllers 30 to control the motors 26 at different speeds such as by ramping up or ramping down the motor speeds. The irrigation system 10 may use the increased or decreased motor speeds to increase or decrease the amount of water received by a swath of crops in addition to the increased or decreased irrigation fluid output of the nozzles 16. For example, if the nozzles 16 are already dispensing water at maximum output along the first swath of crops but the crops still need more water, the irrigation system 10 may slow down. Similarly, if the crops need only a small amount of water, the irrigation system 10 may speed up instead of or in addition to reducing irrigation fluid output.

The irrigation system 10 may continue moving and irrigating indefinitely until instructed to stop or shut down. In this way, the irrigation system 10 may irrigate a field with little or no user input. The irrigation system 10 may also pause or temporarily shut down when it is raining or when irrigation fluid is not needed, during severe weather, when a malfunction is detected, or before routine maintenance.

As mentioned above, the irrigation system 10 may communicate with the remote computer systems and servers 38 and mobile computing device 40 over the wireless communication network 42 for receiving primary or supplementary crop data analysis and/or for receiving backup input or additional input such as weather information and user inputted commands. For example, the processor 28 may determine that the crops require a large amount of water. The processor 28 may then receive weather information from the local weather station forecasting a small amount of rain. The processor 28 may then decrease the required water amount by the forecasted rain amount. As another example, the processor 28 may determine that a malfunction has occurred and that the crops are not receiving enough water or are receiving too much water despite data indicating otherwise. The processor 28 may generate backup commands to initiate an emergency or precautionary irrigation mode in which water is dispensed along the entire irrigation system or in which the entire irrigation system is shut down or switched to a low water mode. Alternatively, the processor 28 may defer to the remote computer system or human input when a malfunction has been detected.

The above-described irrigation system 10 provides several advantages over conventional irrigation systems. For example, the closed-loop, real-time control scheme responds to crop water requirements immediately, which reduces or eliminates crop stress, increases crop uniformity, increases crop yield, saves water, and reduces pumping costs. The irrigation system 10 may operate independently with little or no user input, which reduces labor costs and frees farmers to complete other tasks. The irrigation system 10 may easily be repurposed for different crops and fields. In addition, the sensors 20 are all located on the irrigation system 10, which simplifies maintenance and allows the irrigation system 10 to be easily modified or adapted for changing conditions.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An irrigation system for irrigating crops in a field, the irrigation system comprising:
a series of mobile towers connected to one another by support structure, each mobile tower having wheels and a motor for driving at least one of the wheels;
an irrigation fluid conduit extending between the mobile towers;
a plurality of irrigation nozzles connected to the conduit for dispensing an irrigation fluid;
a plurality of sensors spaced in front of the conduit, the sensors being configured to sense crop information as the irrigation system moves through the field; and
a control system configured to receive data from the sensors representative of the crop information and operate the motors and nozzles for irrigating the crops according to the sensed crop information in real time as the irrigation system moves through the field.

2. The irrigation system of claim 1, wherein the irrigation nozzles have a predetermined spray range and the sensors are positioned in front of the spray range.

3. The irrigation system of claim 2, wherein the sensors are positioned approximately forty feet in front of the nozzles.

4. The irrigation system of claim 1, wherein the irrigation system further comprises a plurality of booms extending forwardly from the support structure, the sensors being positioned near the ends of the booms.

5. The irrigation system of claim 1, wherein the sensors are configured to sense crop leaf canopy temperatures.

6. The irrigation system of claim 5, wherein the control system is configured to calculate crop water stress indices (CWSIs) corresponding to the crop leaf canopy temperatures and operate the motors and nozzles for irrigating the crops according to the CWSIs in real time.

7. The irrigation system of claim 1, wherein the control system is configured to communicate with a remote irrigation management system for receiving user input, the control system being configured to operate the motors and nozzles according to the sensed crop information and the user input.

8. The irrigation system of claim 1, wherein the control system is configured to communicate with weather stations for ensuring that the control system is irrigating the crops within predetermined limits.

9. The irrigation system of claim 1, further comprising a plurality of stationary soil moisture sensors positioned in the field, the control system being configured to operate the motors and nozzles according to the sensed crop information and moisture levels sensed by the soil moisture sensors.

10. The irrigation system of claim 1, wherein the control system is configured to operate in at least an automatic mode, wherein the control system is configured to switch to the automatic mode only after a designated soil moisture reservoir has reached field capacity.

11. The irrigation system of claim 1, wherein the control system is configured to operate the motors and nozzles for irrigating the crops according to the sensed crop information in real time only after the crops have a substantially developed canopy.

12. The irrigation system of claim 1, wherein the control system is configured to operate the motors and nozzles for irrigating the crops according to the sensed crop information continuously in real time without any user input.

13. The irrigation system of claim 1, wherein the nozzles are variable flow rate nozzles and the irrigation system is a variable rate irrigation (VRI) system.

14. The irrigation system of claim 1, wherein the motors are variable frequency drive (VFD) motors.

15. The irrigation system of claim 1, wherein the irrigation system is a center pivot irrigation system.

16. A method of irrigating crops in a field, the method comprising the steps of:
providing an irrigation system comprising:
a series of mobile towers connected to one another by support structure, each mobile tower having wheels and a motor;
an irrigation fluid conduit extending between the mobile towers;
a plurality of irrigation nozzles connected to the conduit;
a plurality of sensors connected to the support structure and positioned a predetermined distance in front of the conduit; and
a control system for operating the motors and nozzles;
controlling the motors to drive the wheels of the mobile towers so as to position the sensors near a first swath of crops;
sensing a first set of crop information corresponding to the first swath of crops;
determining a first set of irrigation fluid amounts needed by the first swath of crops based on the first set of crop information;
controlling the motors to drive the wheels of the mobile towers so as to position the irrigation nozzles near the first swath of crops and simultaneously position the sensors near a second swath of crops;
increasing or decreasing irrigation fluid output of each nozzle according to the first set of irrigation fluid amounts;
sensing a second set of crop information corresponding to the second swath of crops;
determining a second set of irrigation fluid amounts needed by the second swath of crops based on the second set of crop information;
controlling the motors to drive the wheels of the mobile towers so as to position the irrigation nozzles near the second swath of crops; and
increasing or decreasing irrigation fluid output of each nozzle according to the second set of irrigation fluid amounts.

17. The method of claim 16, further comprising the steps of controlling the motors to continuously or nearly continuously advance the sensors and nozzles along an irrigation path, continuously or nearly continuously generating crop information between the first set of crop information and the second set of crop information as the motors advance the sensors along the irrigation path, and continuously or nearly continuously controlling irrigation fluid output for each nozzle as the motors advance the nozzles along the irrigation path.

18. The irrigation system of claim 1, wherein the crop information includes crop leaf canopy temperatures.

19. The irrigation system of claim 16, wherein the steps of determining irrigation fluid amounts needed by the crops includes calculating crop water stress indices (CWSIs) corresponding to the crop leaf canopy temperatures.

20. A center pivot irrigation system for irrigating crops in a field, the irrigation system comprising:
a series of mobile towers connected to one another by support structure, each mobile tower having wheels and a variable frequency drive motor for driving at least one of the wheels;
an irrigation fluid conduit extending between the mobile towers;
a plurality of variable flow rate irrigation nozzles connected to the conduit for dispensing an irrigation fluid, the variable flow rate irrigation nozzles having a spray range of approximately 20 feet in front of the support structure;
a plurality of booms extending forwardly approximately 40 feet from the support structure, the booms being configured to be selectively raised and lowered;
a plurality of temperature sensors positioned on the ends of the booms so as to be spaced approximately forty feet in front of the conduit, the sensors being configured to sense crop leaf canopy temperatures as the irrigation system moves through the field; and
a control system comprising:
a transceiver for receiving weather information from a weather station and user input from a user's mobile device including control instructions for operating the motors and nozzles; and
a processor configured to analyze data received from the sensors representative of the crop leaf canopy temperatures and generate control instructions for operating the motors and nozzles for irrigating the crops according to the user input, the weather information, and crop water stress indices (CWSIs) calculated as a function of the crop leaf canopy temperatures in real time as the irrigation system moves through the field.
